(19) United States
(12) Patent Application Publication
(10) Pub. No.: US 2009/0310290 A1
(43) Pub. Date: Dec. 17, 2009

(54) WEARABLE DISPLAY MEDIA

(76) Inventor: James TENNENT, Uxbridge (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(21) Appl. No.: 12/481,768

(22) Filed: Jun. 10, 2009

Related U.S. Application Data
(60) Provisional application No. 61/060,615, filed on Jun. 11, 2008.

(51) Int. Cl. G06F 1/16; G01C 21/00

(52) U.S. Cl. 361/679.03; 701/213

(57) ABSTRACT

A system and method for displaying visual content on a piece of clothing. This is achieved by utilizing a flexible display attached to or forming a part of the clothing. The content displayed on the flexible display is provided by a video controller connected to a computer, both of which reside in the clothing. Content may be provided via wireless transmission or through a Universal Serial Bus. The computer communicates wirelessly through a network to a server which serves up content and tracks information on user location and types of content displayed.

### CROSS REFERENCE TO RELATED APPLICATIONS

This application claims the benefit of priority of U.S. Provisional Patent Application No. 61/060,615 filed Jun. 11, 2008 which is incorporated herein by reference in its entirety.

### FIELD OF THE INVENTION

The present invention relates to clothing that contains a high resolution flexible display connected to a computing device that allows for content to be shown on the display.

### BACKGROUND OF THE INVENTION

Embodiments as disclosed herein utilize a flexible display. One such display developed by Sony Inc. is a flexible full colour Organic Light Emitting Diode (OLED) built on organic thin-film transistor (TFT) technology on a flexible plastic substrate. Another such display is provided by E-ink, a company providing an Electronic Paper Display (EPD). E-ink has produced an extremely thin and flexible non distorting high resolution display. These qualities and the fact that this is a new medium for viewing information and media permit, many applications. The most obvious are in the form of thinner screens for video, cell phones, and personal computing devices. This new form of high resolution display will allow for more public displays of popular culture media by individuals. In the past nobody could reasonably wear plasma screens or LCD screens as a form of or as a part of clothing because the technology was still too bulky, heavy and would require a considerable power source.

### SUMMARY OF THE INVENTION

EPDs are reflective and can be easily read in bright sunlight or dimly lit environments while being able to be seen at virtually any angle—just like paper. EPD's and OLED's hereinafter referred to as “flexible displays”, provide unique technology which results in a compact and lightweight form factor making them ideal for highly portable applications.

The application is directed to a wearable piece of clothing comprising a flexible display, the flexible display connected to a display controller designed to provide content to be displayed, the display controller connected to a processor board designed to provide instructions to the display controller, and a power source such as a battery pack connected to the display controller and the processor board to provide power to each.

### BRIEF DESCRIPTION OF THE DRAWINGS

Embodiments will now be described, by way of example only, with reference to the attached Figures, wherein:

FIG. 1 is a block diagram of a system according to an embodiment;

FIG. 2 is a front view of a piece of clothing comprising an embodiment of the system herein;

FIG. 3 is a schematic diagram of a main processor and associated components;

FIG. 4 is a rear view of a piece of clothing comprising an embodiment of the system herein; and

FIG. 5 is a rear view of a piece of clothing comprising an embodiment of the system herein.

### DETAILED DESCRIPTION

Embodiments as disclosed herein involve the use of flexible displays in both monochromatic and colour formats. There may be one or more flexible displays and they may be utilized to display a single picture or utilized as a video display showing moving pictures such as streaming video. The flexible displays along with their supporting computer hardware are incorporated into the clothing in a manner that does not restrict the function of the garment as well as being shock proof and water proof by being contained in a sealed case, within a waterproof pocket.

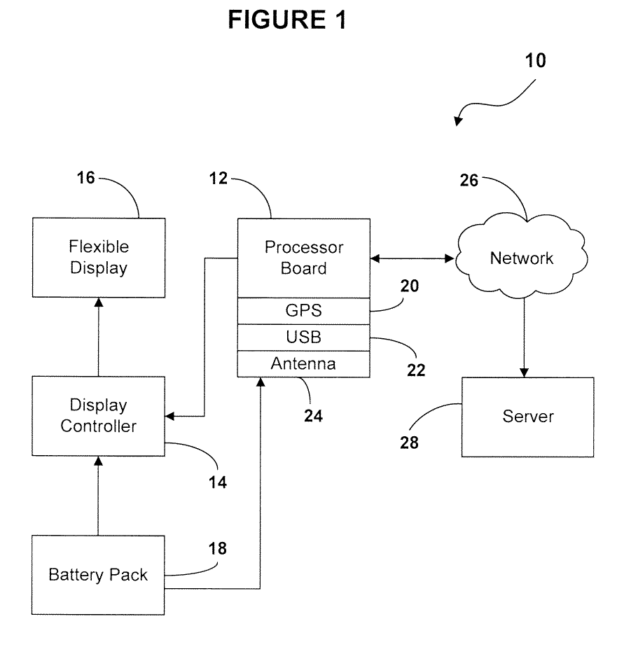

Referring first to FIG. 1 a block diagram of a system according to an embodiment is shown generally as 10. System 10 comprises a processor board 12 connected to a display controller 14. Processor board 12 provides instructions to display controller 14 regarding the content to be displayed on flexible display 16. Power source, or battery pack, 18 provides power for both display controller 14 and processor board 12. Processor board 12 further comprises hardware to support a Global Positioning System in the form of GPS 20. GPS 20 is utilized to determine the location of the wearer of the flexible display 16. Processor board 12 also comprises a Universal Serial Bus in the form of USB 22, to allow the importing of content such as streaming video from a device capable of storing and sending audio and video information.

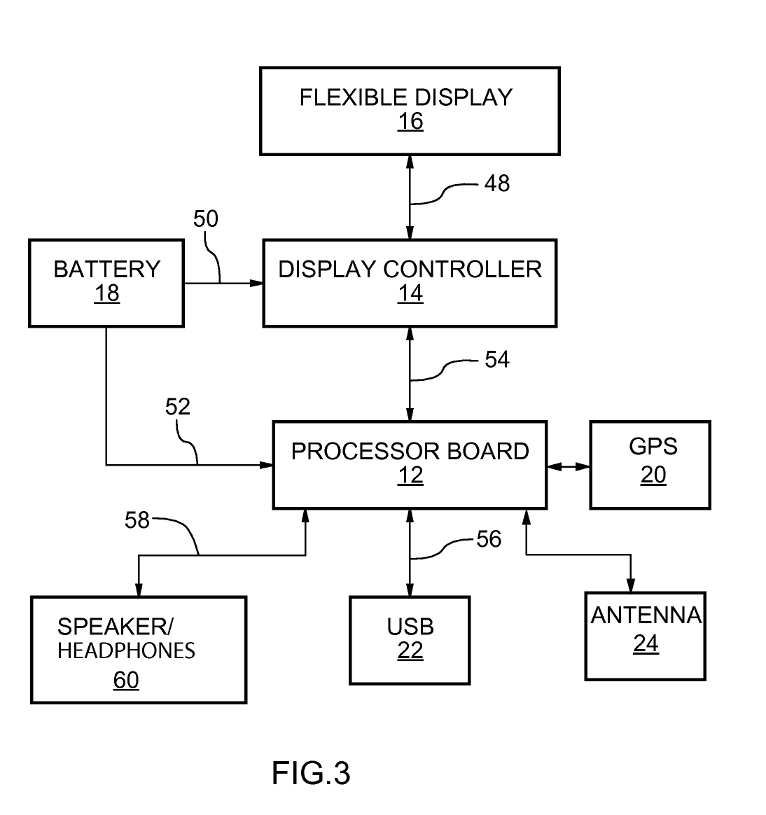

Processor board 12 also comprises a wireless antenna 24 for receiving and sending information to network 26. Network 26 may be any form of wireless network. Server 28 tracks the content delivered to processor board 12 for display on flexible display 16 as well as the location of the user for the purpose of suggesting content. Processor board 12 is described in more detail with reference to FIG. 3.

It is the intent of the inventors that the processor board 12, the display controller 14, the flexible display 16 and the power source, or battery pack, 18 be contained within the clothing. By doing so no external cables or devices are required.

An example of suitable clothing would be a jacket or vest. Currently flexible displays cannot be stitched but can be glued with a flexible adhesive onto an appropriate fabric base that would allow for the incorporation of one main panel in a form of clothing or in order to provide a flexible seam when piecing together more than one panel. The technology used to link the panels while viewing streaming video would utilize the same type of technology used to link multiple computer screens to form one large screen, as known to one skilled in the art.

The processor board 12, display controller 14 and power source, or battery pack, 18 are enclosed in a shock resistant case and are sewn or otherwise attached to the piece of clothing in a neoprene (or other waterproof material) pocket with some form of access, such as zipper, Velcro or dome snaps. This pocket would protect where the display controller 14 connects directly to the flexible display 16.

Similarly the cables connecting the various components would be sewn or otherwise attached to the piece of clothing.

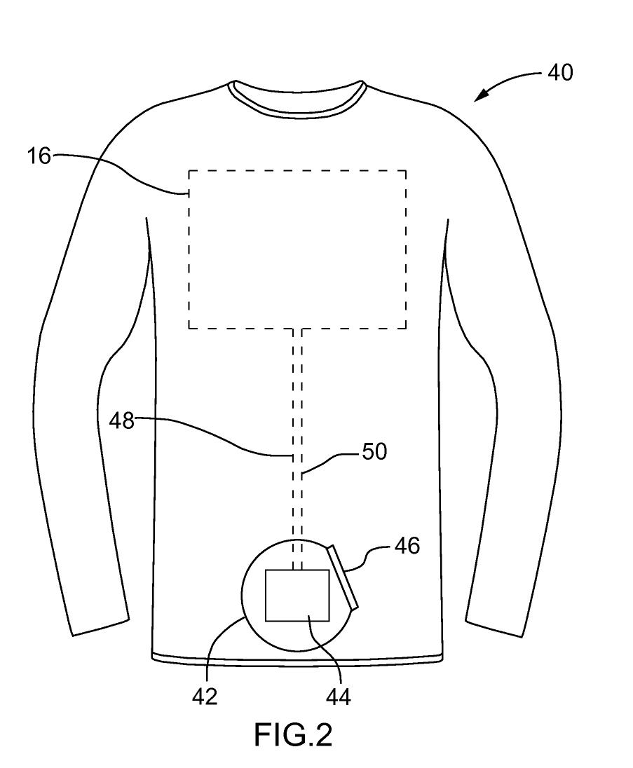

Referring now to FIG. 2 a front view of a piece of clothing comprising an embodiment of a system herein is shown. A piece of clothing 40 comprises a pocket pouch 42 to house a shock resistant container 44 in which are contained processor board 12, power source, or battery pack, 18, and display controller 14, as down in FIG. 1. Pocket pouch 42 is sealed by velcro strip 46 or another means such as a zipper, or buttons. Cable 48 connects display controller 14 to clothing flexible display 16. Cable 50 provides power to clothing flexible display 16, via power source, or battery pack, 18.

Although FIG. 2 illustrates a long sleeved jacket or shirt, it is not the intent of the inventors to restrict embodiments of this invention to a specific style of clothing. In addition, pocket pouch 42 may be located anywhere in the piece of clothing 40. Pocket pouch 42 is shown as being centrally located, but could certainly be laterally located in the traditional pocket position.

Referring now to FIG. 3 a schematic diagram of a main processor and associated components is shown. Processor board 12 in one embodiment utilizes the Gumstix single-board computer, which combines a 400 MHz Intel Xscale PXA255 processor with a Bluetooth transceiver, Universal Serial Bus (USB 22), a serial port and a Multimedia Card (MMC). Power source, or battery pack, 18 provides power to display controller 14 via connection 50 and to processor board 12 via connection 52. Processor board 12 is connected to display controller 14 by cable 54. Display controller 14 is further connected to flexible display 16 via cable 48. A speaker or headphone jack 60 may optionally be connected to processor board 12.

GPS 20 in one embodiment utilizes a patch antenna manufactured by SiRF Technology Inc. as their Start II chip set. Positioning data is reported via USB (wired) or Bluetooth (wireless) communication using the National Marine Electronics Association 0183 standard (NMEA0183).

Wireless data communication will be sent using Antenna 24 over networks using protocols such as IEEE 802.11, Code Division Multiple Access (CDMA), Global System for Mobile Communication (GSM), or General Packet Radio Service (GPRS). The protocol selected would typically be based upon the most cost effective gateway.

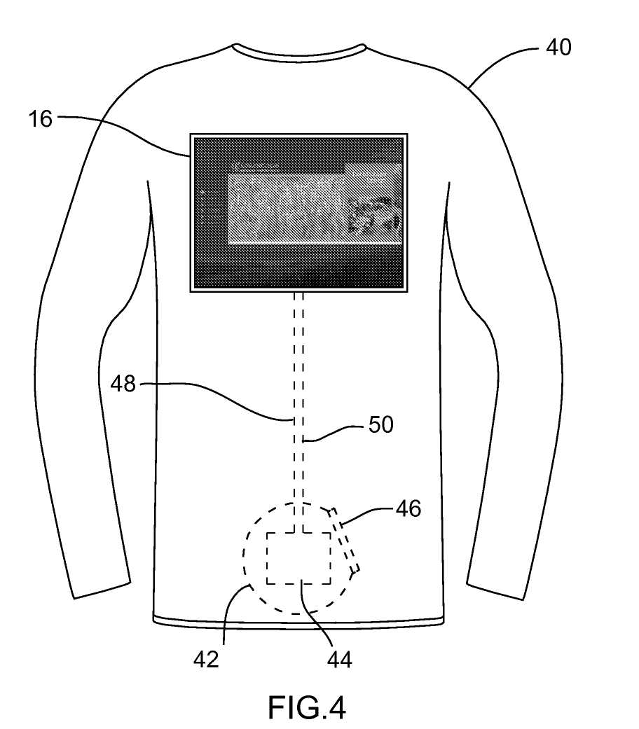

FIG. 4 is a rear view of a piece of clothing comprising an embodiment of the system herein. The features shown in FIG. 4 are generally identical to those described with reference to FIG. 3.

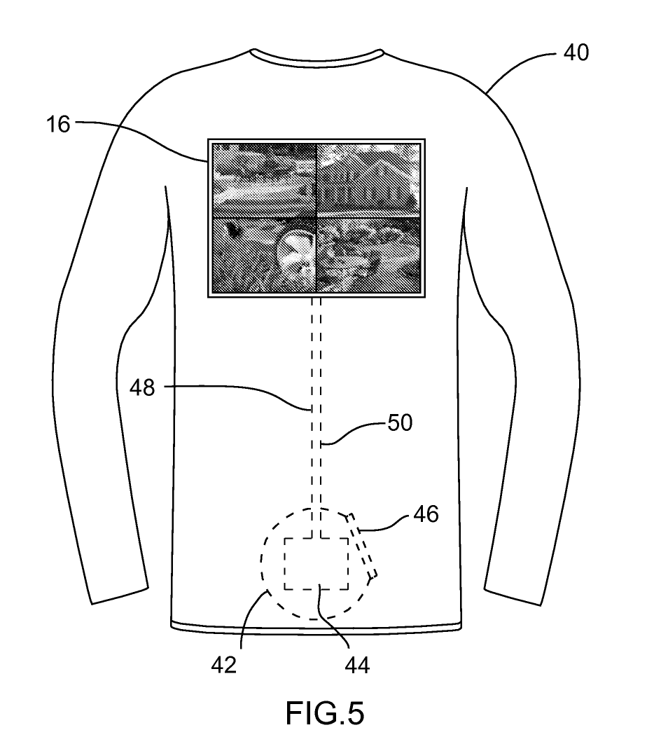

FIG. 5 is a rear view of a piece of clothing comprising an embodiment of the system herein. FIG. 5 is similar to the embodiment of FIG. 4, save that flexible display 16 comprises multiple panels.

Although flexible display 16 has been illustrated as a rectangular shape. It is not the intent of the inventors to restrict embodiments of flexible display 16 to that shape. Oval, circular, triangular and other geometric forms have also been considered.

In more restrictive items of clothing such as baby-Ts and snug shirts the GPS 20, and antenna 24 can be separated into a standalone Bluetooth device to be stored elsewhere such as a purse or pocket. The content and GPS tracking information will be beamed from this secondary unit over the Bluetooth protocol to the processor 12 for direct display.

Software on the processor board 12 will contact server 28 via network 26 at pre-defined intervals to check for new video content to download. This content can be dictated by the company administrating the server 28 or optionally allow users to upload their own content from a home computer for display on their article of clothing. Software captures NMEA data from the GPS 20 and reports what content was displayed, the unit ID, the duration and where the person travelled while it was displayed. This data will be sent in bursts at predefined intervals to the server 28 for reporting.

Utilizing GPS data, the server 28 can determine the general geographical area of the person wearing a display and provide targeted advertising relative to near by businesses. This provides a number of marketing opportunities, for example, an advertising rate for both the company being advertised and the person wearing the display clothing can be established based on various factors such as the population density of the area.

The addition of sound to the hardware in the clothing is also a feature of an embodiment of the system wherein the sound may be transmitted directly from a speaker on processor board 12 or via headphones to the wearer of the clothing (see feature 60 of FIG. 3).

What is claimed is:

1. A wearable piece of clothing comprising:
a flexible display for displaying content;
a display controller connected to the flexible display for controlling the flexible display to display the content;
a processor board connected to the display controller for providing instructions to the display controller; and
a power source connected to the display controller and the processor board for powering the display controller and the processor board.

2. The wearable piece of clothing of claim 1, wherein the content comprises an image.

3. The wearable piece of clothing of claim 1, wherein the content comprises video content.

4 The wearable piece of clothing of claim 1 wherein the content comprises audio content, and wherein the wearable piece of clothing further comprises an audio interface connected to the processor board for communicating the audio content to an audio playback device.

5. The wearable piece of clothing of claim 1 wherein the content comprises audio content, and wherein the wearable piece of clothing further comprises a speaker in communication with the processor board for playing back the audio content.

6. The wearable piece of clothing of claim 1, wherein the flexible display comprises a plurality of flexible display panels.

7. The wearable piece of clothing of claim 1, wherein the display controller, the processor board, and the power source are housed in a shock resistant container.

8. The wearable piece of clothing of claim 7 further comprising a water resistant pocket accessibly surrounding the shock resistant container.

9. The wearable piece of clothing of claim 1 further comprising a Global Positioning System (GPS) receiver for determining the location of the wearable piece of clothing.

10. The wearable piece of clothing of claim 1 further comprising a universal serial bus (USB) for communicating between the processor board and an external device.

11. The wearable piece of clothing of claim 1, further comprising an antenna for wirelessly communicating between the processor board and an external device.

12. The wearable piece of clothing of claim 1, wherein the content displayed on the flexible display is at least partially based on the location of the user.

13. A system for displaying content on a wearable piece of clothing comprising:
a wearable piece of clothing comprising:
a flexible display for displaying content;
a display controller connected to the flexible display for controlling the flexible display to display the content;
a processor board connected to the display controller for providing instructions to the display controller; and
a power source connected to the display controller and the processor board for powering the display controller and the processor board; and
an antenna for wirelessly communicating with a server,
wherein the processor board communicates with the server to determine the availability of additional content and to retrieve the additional content.

14. A system for displaying content on a wearable piece of clothing comprising:
a wearable piece of clothing comprising:
a flexible display for displaying content;
a display controller connected to the flexible display for controlling the flexible display to display the content;
a processor board connected to the display controller for providing instructions to the display controller; and
a power source connected to the display controller and the processor board for powering the display controller and the processor board;
an antenna for wirelessly communicating with a server; and
a Global Positioning System (GPS) receiver for determining the location of the wearable piece of clothing,
wherein the processor board collects data and communicates the data to the server, the data including the location of the wearable piece of clothing and data related to the displayed content.
